(19) United States
(12) Patent Application Publication
(10) Pub. No.: US 2026/0272632 A1
(43) Pub. Date: Sep. 17, 2026

(54) SMART TOOTHBRUSH CONTROL METHOD, DEVICE, TERMINAL AND READABLE STORAGE MEDIUM

(71) Applicant: DIMI LIFE TECHNOLOGY CO., LTD., Shenzhen, Guangdong (CN)

(72) Inventors: Qinyang HE, Shenzhen (CN); Rongshan YI, Shenzhen (CN); Wei HOU, Shenzhen (CN); Ning LIU, Shenzhen (CN)

(73) Assignee: DIMI LIFE TECHNOLOGY CO., LTD., Shenzhen, Guangdong (CN)

(21) Appl. No.: 18/847,263

(22) PCT Filed: Oct. 12, 2023
(86) PCT No.: PCT/CN2023/124263

§ 371 Date: Sep. 16, 2024

(51) Int. Cl. A61C 17/22

(52) U.S. Cl. CPC A61C 17/221

(57) ABSTRACT

A smart toothbrush control method, device, terminal, and readable storage medium are provided. The method includes: receiving first indication information sent by a target device; wherein the first indication information is used to indicate at least one of the following: an operating mode of the smart toothbrush, a type of consumables, an amount of the consumables, user oral data collection, consumable usage status collection and smart toothbrush usage status collection; determining a target operating program corresponding to the first indication information, and executing the target operating program; the target device includes an upper machine and/or a smart consumable device.

### TECHNICAL FIELD

The present disclosure relates to the field of toothbrush technology, in particular to a smart toothbrush control method and device, a terminal and a readable storage medium.

### BACKGROUND

In personal health care devices, toothbrushes are an essential device that can help us to clean our mouths, reduce dental plaque, and clean up other bacteria and chemicals that harm teeth. The existing electric toothbrushes only have ordinary fixed brushing functions, and generally only have a plurality of optional fixed gears. Although there are electric toothbrushes with frequency switching function on the market, electric toothbrushes with frequency switching function also adopt fixed gears to provide users with choices, a polling method is used for switching, and direct jumping cannot be achieved, and customization cannot be implemented based on the user's habits and brushing modes. Therefore, ordinary electric toothbrushes have problems such as fixed modes, simple functions, and low efficiency in switching modes.

### SUMMARY

In one aspect, the present disclosure provides in some embodiments a smart toothbrush control method, applied to a smart toothbrush, including: receiving first indication information sent by a target device; wherein the first indication information is used to indicate at least one of the following: an operating mode of the smart toothbrush, a type of consumables, an amount of the consumables, user oral data collection, consumable usage status collection and smart toothbrush usage status collection; determining a target operating program corresponding to the first indication information, and executing the target operating program; wherein the target device includes an upper machine and/or a smart consumable device.

Optionally, the operating mode of the smart toothbrush includes at least one of the following: a movement mode, vibration intensity, a working frequency and working duration of a toothbrush head; the type of consumables include toothpaste, mouthwash and a cleaning agent.

Optionally, the target device includes the upper machine, and the determining a target operating program corresponding to the first indication information, and executing the target operating program includes: determining the target operating program according to the first indication information; wherein the target operating program includes: using target consumables with a target amount, running in a target operating state, and sending at least one of the following to the upper machine and/or a cloud device: the user oral data, a usage status of the consumables, and a usage status of the smart toothbrush.

Optionally, the target device includes the smart consumable device, and determining the target operating program corresponding to the first indication information and executing the target operating program includes: determining the target operating program according to the first indication information; wherein the target operating program includes: using a target amount of consumables, running in a target operating state, and storing at least one of the following: the user oral data, a usage status of the consumables, and a usage status of the smart toothbrush; the first indication information is determined based on user data stored in the smart consumable device.

Optionally, the smart toothbrush control method further includes: after detecting a first upgrade request sent by the upper machine, downloading a first data packet from the upper machine; verifying the first data packet, and sending an upgrade mode request to the upper machine after the verification is successful; performing firmware upgrade according to the first data packet, according to upgrade mode confirmation information fed back by the upper machine; wherein the upgrade mode includes scheduled upgrade and/or upgrade during idle.

Optionally, the first data package includes a consumables upgrade package, and the performing the firmware upgrade according to the first data packet according to the upgrade mode confirmation information fed back by the upper machine includes: detecting a first consumable currently used, and determining a first target data packet corresponding to the first consumable in the first data packet; sending the first target data packet to the smart consumable device, and saving remaining data of the first data packet; after receiving the upgrade completion information sent by the smart consumable device, reading the first data packet of the first consumable in the smart consumable device and determining whether the first consumable is successfully upgraded; when it is detected that a second consumable is replaced, detecting a first data packet of the second consumable in the smart consumable device, and after it is determined that the second consumable has not been successfully upgraded, sending a second target data packet corresponding to the second consumable in the first data packet to the smart consumable device.

Optionally, the smart toothbrush control method further includes: after detecting the second upgrade request sent by the upper machine, determining a upgrade time according to the operating status of the smart toothbrush, and feeding back the upgrade time to the upper machine; the upgrade time being a time after a current time; if the second upgrade request sent by the upper machine is received at the upgrade time, determining whether to upgrade according to the operating status of the smart toothbrush.

In a second aspect, an embodiment of the present disclosure provides a smart toothbrush control method, applied to an upper machine, including: sending first indication information to a smart toothbrush; wherein the first indication information is used to indicate at least one of the following: an operating mode of the smart toothbrush, a type of consumables, a amount of consumables, user oral data collection, consumable usage status collection, and smart toothbrush usage status collection.

Optionally, the method further includes: receiving at least one of the following collection data sent by the smart toothbrush: the user oral data, the usage status of the consumables, and the usage status of the smart toothbrush; sending at least one of the collection data to a cloud device.

Optionally, the method further includes: receiving a third upgrade request sent by the cloud device; upon receiving indication information input by a user to confirm the upgrade, downloading a second data package for the upgrade from the cloud device; upgrading the upper machine according to the second data package.

Optionally, the method further includes: when a first upgrade request sent by the cloud device is detected, sending the first upgrade request to the smart toothbrush; receiving an upgrade mode request fed back the smart toothbrush; determining upgrade mode confirmation information of the smart toothbrush according to third control data input by the user; sending the upgrade mode confirmation information to the smart toothbrush.

Optionally, the method further includes: when a second upgrade request sent by the cloud device is detected, sending the second upgrade request to the smart toothbrush; the second upgrade request being used to indicate the firmware upgrade of the smart consumable device; receiving an upgrade time fed back by the smart toothbrush; when the upgrade time is a time after a current time, sending the second upgrade request to the smart toothbrush at the upgrade time.

Optionally, the method further includes: when a duration between the upgrade time and the current time is greater than a preset value, exiting the current upgrade.

In a third aspect, an embodiment of the present disclosure provides a smart toothbrush control method, applied to a smart consumable device, including: sending first indication information to a smart toothbrush; wherein the first indication information is used to indicate at least one of the following: an operating mode of the smart toothbrush, a usage amount of consumables, collection and storage of user oral data, collection and storage of usage status of consumables, and collection and storage of usage status of the smart toothbrush; the first indication information is determined based on user data stored in the smart consumable device.

Optionally, the method further includes: receiving a first target data packet sent by the smart toothbrush, wherein the first target data packet is an upgrade package corresponding to a first consumable contained in the smart consumable device; performing firmware upgrade of the smart consumable device according to the first target data package.

Optionally, the method further includes: downloading a second data package from a cloud device; performing firmware upgrade according to the second data package.

In a fourth aspect, an embodiment of the present disclosure provides a smart toothbrush control device, including: a receiving module, configured to receive first indication information sent by a target device; wherein the first indication information is used to indicate at least one of the following: an operating mode of the smart toothbrush, a type of consumables, an amount of the consumables, user oral data collection, consumable usage status collection and smart toothbrush usage status collection; a determining module, configured to determine a target operating program corresponding to the first indication information, and execute the target operating program; wherein the target device includes an upper machine and/or a smart consumable device.

In a fifth aspect, an embodiment of the present disclosure provides a smart toothbrush control device, including: a first sending module, configured to send the first indication information to a smart toothbrush; wherein the first indication information is used to indicate at least one of the following: an operating mode of the smart toothbrush, a type of consumables, a amount of consumables, user oral data collection, consumable usage status collection, and smart toothbrush usage status collection.

In a sixth aspect, an embodiment of the present disclosure provides a smart toothbrush control device, including: a second sending module, configured to send first indication information to a smart toothbrush; wherein the first indication information is used to indicate at least one of the following: an operating mode of the smart toothbrush, a type of consumables, an amount of the consumables, user oral data collection, consumable usage status collection and smart toothbrush usage status collection; the first indication information is determined based on user data stored in the smart consumable device.

In a seventh aspect, an embodiment of the present disclosure provides a terminal, including: a transceiver, a processor, a memory, and a program or instructions stored on the memory and executed by the processor; when the processor executes the program or instructions to implement the smart toothbrush control method.

In an eighth aspect, an embodiment of the present disclosure provides a readable storage medium, storing a computer program, and when the computer program is executed by a processor, the steps of the smart toothbrush control method is implemented.

### BRIEF DESCRIPTION OF THE DRAWINGS

FIG. 1 is a schematic diagram of the steps of a smart toothbrush control method applied to a smart toothbrush according to an embodiment of the present disclosure;

FIG. 2 is a schematic diagram of communication connections among the smart toothbrush, an upper machine and a smart consumable device according to an embodiment of the present disclosure;

FIG. 3 is a schematic diagram of the operation of the smart toothbrush when the upper machine is not connected to a cloud device according to an embodiment of the present disclosure;

FIG. 4 is a schematic diagram of the operation of the smart toothbrush when the smart toothbrush is offline according to an embodiment of the present disclosure;

FIG. 5 is a schematic diagram of an initialization flow of the smart toothbrush according to an embodiment of the present disclosure;

FIG. 6 is a schematic diagram of a wake-up source of the smart toothbrush according to an embodiment of the present disclosure;

FIG. 7 is a logical schematic diagram of the first use of the smart toothbrush according to an embodiment of the present disclosure;

FIG. 8 is a schematic diagram of data synchronization between the smart toothbrush and the upper machine according to an embodiment of the present disclosure;

FIG. 9 is a schematic diagram of the firmware upgrade of the smart toothbrush background upgrade method according to an embodiment of the present disclosure;

FIG. 10 is a schematic diagram of consumable firmware upgrade according to an embodiment of the present disclosure;

FIG. 11 is another schematic diagram of consumable firmware upgrade according to an embodiment of the present disclosure;

FIG. 12 is a schematic diagram of the firmware upgrade of the smart toothbrush online upgrade method according to an embodiment of the present disclosure;

FIG. 13 is another schematic diagram of the firmware upgrade of the smart toothbrush online upgrade method according to an embodiment of the present disclosure;

FIG. 14 is a schematic diagram of the steps of a smart toothbrush control method applied to the upper machine according to an embodiment of the present disclosure;

FIG. 15 is a schematic diagram of the firmware upgrade process of the cloud device according to an embodiment of the present disclosure;

FIG. 16 is a schematic diagram of the steps of the smart toothbrush control method applied to smart consumable devices according to an embodiment of the present disclosure;

FIG. 17 is a first structural schematic diagram of the smart toothbrush control device according to an embodiment of the present disclosure;

FIG. 18 is a second structural schematic diagram of the smart toothbrush control device according to an embodiment of the present disclosure;

FIG. 19 is a third structural schematic diagram of the smart toothbrush control device according to an embodiment of the present disclosure;

FIG. 20 is a schematic structural diagram of a terminal according to an embodiment of the present disclosure.

### DETAILED DESCRIPTION

The following will clearly and completely describe the technical solutions in the embodiments of the present disclosure with reference to the accompanying drawings. Obviously, the described embodiments are only some of the embodiments of the present disclosure, not all of them. Based on the embodiments in the present disclosure, all other embodiments obtained by those ordinary skill in the art without making creative work belong to the protection scope of the present disclosure.

The terms “first”, “second”, etc. in the description and claims of the present disclosure are used to distinguish similar objects and are not used to describe a specific order or sequence. It is to be understood that the data are interchangeable under appropriate circumstances so that embodiments of the present disclosure can be practiced in sequences other than those illustrated or described herein. In addition, “and/or” in the description and claims indicates at least one of the connected objects, and the character “/” generally indicates that the related objects are in an “or” relationship.

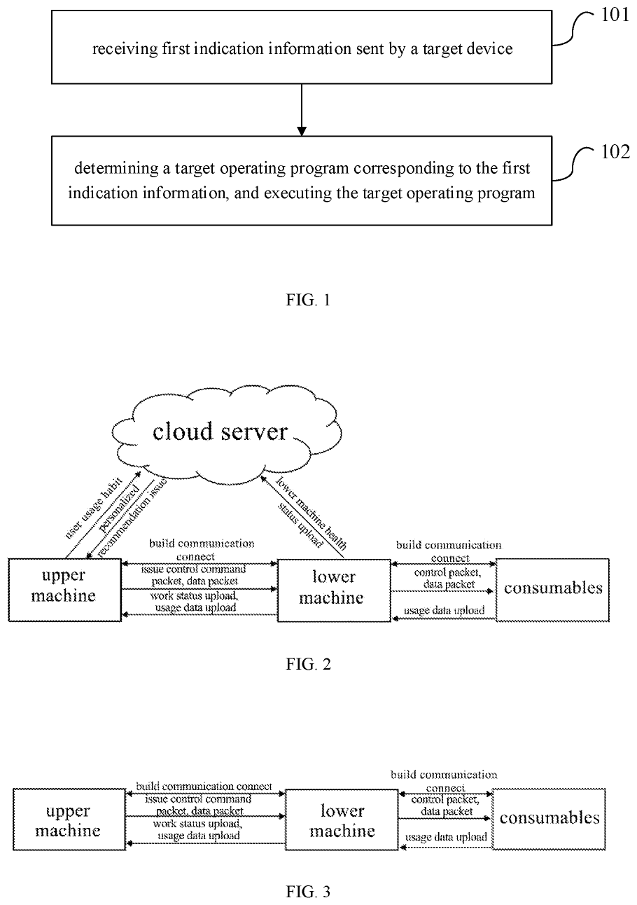

The smart toothbrush control method provided by the embodiment of the present disclosure will be described in detail below with reference to FIGS. 1 to 15 through specific embodiments and application scenarios.

As shown in FIG. 1, the smart toothbrush control method according to the embodiment of the present disclosure is applied to smart toothbrushes and includes the following steps:
Step 101: receiving first indication information sent by a target device; wherein the first indication information is used to indicate at least one of the following: an operating mode of the smart toothbrush, a type of consumables, an amount of the consumables, user oral data collection, consumable usage status collection and smart toothbrush usage status collection;

Step 102: determining a target operating program corresponding to the first indication information, and executing the target operating program;

The target device includes: an upper machine and/or a smart consumable device.

Optionally, the first indication information may be a control command packet or a data packet.

Optionally, the user oral data may be visual images or data.

Optionally, the consumable usage status and the smart toothbrush usage status are both visual data.

Optionally, the operating mode of the smart toothbrush includes at least one of the following:

a movement mode, vibration intensity, a working frequency and working time of a toothbrush head;

The type of consumables include: toothpaste, mouthwash and cleaning agents.

Optionally, the smart toothbrush usage status includes:

Number of uses, time of use and a current working mode.

Optionally, the consumable usage status includes:

Number of uses, a remaining amount and a current working mode.

Optionally, the upper machine includes:

a wearable smart watch, a mobile phone, a personal computer or a laptop.

In some embodiments, for example, the upper machine is in an online state. The upper machine can set all working states of the smart toothbrush, including but not limited to: a smart toothbrush upgrade mode, a smart toothbrush operating mode, firmware upgrade of the smart consumable device, scheduled sending and receiving of synchronized data, display of working status indicators, a vibration frequency, intensity and time of a sonic motor of the smart toothbrush, selection of consumables, and an amount of used consumables.

In other embodiments, for example, the upper machine is in an offline state. For different consumables, the smart toothbrush also has corresponding modes to meet the corresponding modes required by different consumables to run the smart toothbrush.

The upper machine is in an online state. When the user needs to brush his teeth, as shown in FIG. 2, the upper machine will first customize the brushing operating mode, consumables used when brushing, the amount of used consumables, customized indicators, etc.; the brushing operating modes include: vibration frequency and intensity of the toothbrush and brushing duration;

The user can also select a system preset mode and choose to start brushing. At this time, the upper machine will send the user-defined control data packet about the working mode of the smart toothbrush to the lower machine (the smart toothbrush). When the user uses the smart toothbrush, the user can start brushing under a certain selected working mode.

Optionally, sending, by the upper machine, the user-defined control data packets about the working mode of the smart toothbrush to the smart toothbrush, includes:

Sending the control data packet to the smart toothbrush through a heartbeat packet.

Optionally, after receiving the control data packet, the smart toothbrush checks and overwrites the currently controlled working mode, so that it can be directly called during the next time of working. At the same time, since the lower machine is a battery-based product, when the user uses it, the usage data (smart toothbrush usage status, consumable usage time, etc.) of the user are reported in time, so that the upper machine can obtain the user's usage habits in a timely manner. The algorithm can optimize the user's experience of using the upper machine.

The upper machine can automatically optimize and set the corresponding working mode of the lower machine after the user uploads the usage data (personal health data), thereby avoiding the need for the user to re-set the working mode of the lower machine every time he brushes his teeth, making it convenient for users to use. The upper machine can automatically generate toothbrush methods for a week, a month or even a year based on user usage data for users to choose. It is automatically sent to the lower machine every time brushing is performed. If the lower machine is not connected to the upper machine, or the upper machine determines that there is no need to change the data in the current lower machine and consumables, the above setting is automatically completed by directly using the information stored in the consumables and the information stored in the lower machine to the above settings and run normally.

Through the above solution, users can use smart toothbrushes more simply and conveniently, and can match corresponding brushing modes according to different types of consumables and different users' usage habits to meet users' personalized brushing needs. Moreover, the lower machine can selectively synchronize user usage data to the upper machine, so that users can monitor their usage habits, oral cleaning effects, etc. in real time on the upper machine.

Optionally, the connection status of the smart toothbrush includes an online status that is communicatively connected to the upper machine, and an offline status that is not communicatively connected to the upper machine.

Optionally, the communication method after the communication connection between the smart toothbrush and the upper machine includes at least one of the following:

WIFI, Bluetooth Low Energy (BLE), 868, SparkLink, wireless mesh network (Mesh), Zigbee and other short-distance communications;

4G, 5G, lora, 433, Narrow Band Internet of Things (NB-IoT) and other long-distance communications.

Optionally, the communication method between the smart toothbrush and the smart consumable device includes at least one of the following:

Wireless methods such as Near Field Communication (NFC) and Bluetooth Low Energy (BLE);

Inter-Integrated Circuit (IIC), Serial Peripheral Interface communication protocol (Serial Peripheral Interface, SPI), Universal Asynchronous Receiver/Transmitter (UART), private single-wire protocol and other wired methods.

In the smart toothbrush control method of the embodiment of the present disclosure, the smart toothbrush determines the target operating program based on the first indication information sent by the target device including the upper machine and/or the smart consumable device, and the user can customize the operating mode, consumables type and amount of consumables through the target device, thereby achieving a personalized brushing experience and solving the problems of existing electric toothbrushes with fixed modes, simple functions and low efficiency in switching modes.

Optionally, the operating mode of the smart toothbrush includes at least one of the following:

a movement method, vibration intensity, working frequency and working time of the toothbrush head;

The types of consumables include: toothpaste, mouthwash and cleaning agents.

Optionally, the target device includes the upper machine, and determining the target operating program corresponding to the first indication information and executing the target operating program includes:

Determining the target operating program according to the first indication information;

The target operating program includes: using target consumables with a target amount, running in a target operating state, and sending at least one of the following to the upper machine and/or a cloud device: the user oral data, the usage status of the consumables, and the usage status of the smart toothbrush.

The target device includes the upper machine, that is, the smart toothbrush is in an online state. At this time, the priority of the upper machine is the highest. If the smart toothbrush receives the first indication information of the upper machine and the smart consumable device at the same time, the upper machine shall prevail.

Optionally, the online state of the smart toothbrush includes the following two situations:

The smart toothbrush is connected to the upper machine through communication, and the upper machine is connected to the cloud device;

The smart toothbrush is communicatively connected to the upper machine, but the upper machine is not connected to the cloud device.

In some embodiments, the upper machine communicates with the cloud server, as shown in FIG. 2, and uploads the consumable usage status and the smart toothbrush usage status in a timely manner, so that the consumables suitable for the user can be recommended before the user's consumables are about to be used up, the smart toothbrush reminds the user to recharge when the battery is low, a brush head suitable for the user is recommended after the brush head has been used for a long time, and a personalized smart toothbrush suitable for the user is recommended when the smart toothbrush has been used for a long time; it can also receive scheduled message push, including efficient use methods and tips for the lower machine and consumables; in addition, the user's oral health status can also be collected; at the same time, the upper machine can analyze the user's usage habits and oral health status based on the powerful computing power of the cloud server; the lower machine can also regularly upload the user's oral health data to the cloud server.

In other embodiments, when the upper machine at the user's location cannot connect to the cloud server, as shown in FIG. 3, the user can still use the upper machine to fully control the smart toothbrush and consumables. Different operating modes corresponding to different consumables can be issued through the upper machine, and are not limited to the preset modes in the internal storage area of the consumables. At the same time, the upper machine will still read and store the usage data of the smart toothbrush and consumables so that the data can be uploaded the next time it is connected to the cloud server.

In the smart toothbrush control method of the embodiment of the present disclosure, the smart toothbrush determines the target operating program according to the first indication information sent by the upper machine, and then executes the target operating program. The user can enjoy the convenience of the electric toothbrush and customize tooth brushing mode solutions for different groups and users at the same time.

Optionally, the target device includes the smart consumable device, and determining the target operating program corresponding to the first indication information and executing the target operating program includes:

Determining the target operating program according to the first indication information;

The target operating program includes: using a target amount of consumables, running in a target operating state, and storing at least one of the following: the user's oral data, the usage status of the consumables, and the usage status of the smart toothbrush;

Determining the first indication information based on user data stored in the smart consumable device.

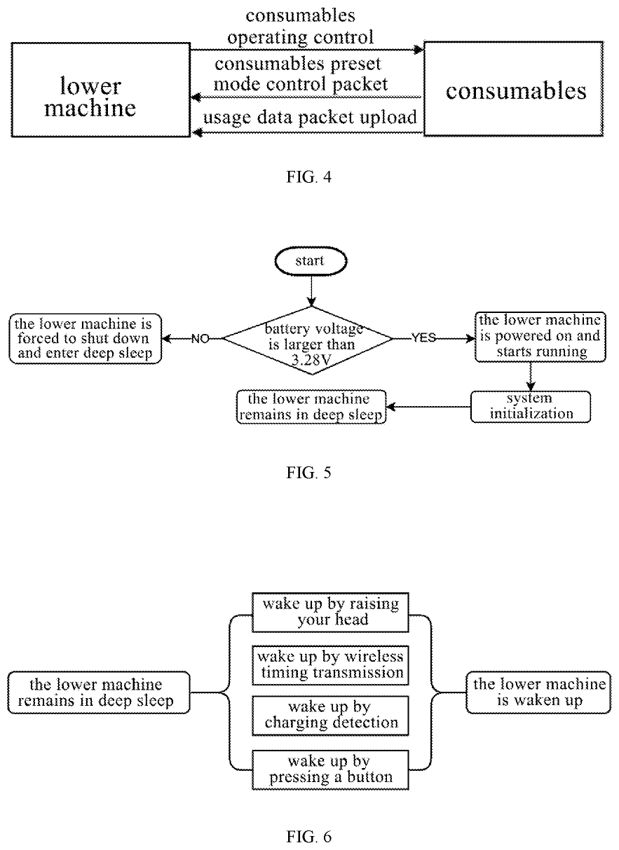

In some embodiments, the smart toothbrush is offline. When the user is distant from the upper machine when using the smart toothbrush, so that the upper machine cannot communicate with the smart toothbrush. At this time, when the smart toothbrush is running, it will work in the preset mode stored in the smart consumable device. As shown in FIG. 4, each consumable contained in the smart consumable device has its own preset or saved working mode (such as the operating mode of the smart toothbrush previously used by the user). When the smart toothbrush uses different consumables offline, different working modes may be obtained, so that users can still use customized usage modes even when offline. At the same time, when the smart toothbrush is offline, it will actively store the usage data of the smart toothbrush, the usage data of consumables, and the collected user oral data, so that it is connected to the upper machine next time, these data can be uploaded to In the upper machine, the upper machine uploads data to the cloud server.

In the smart toothbrush control method of the embodiment of the present disclosure, regardless of whether the smart toothbrush is in an online state connected to the upper machine or in an offline state not connected to the upper machine, the user can brush teeth through the preset toothbrush operating state, achieving a comprehensive customized tooth brushing experience.

In some embodiments, in order to save the standby power consumption of the lower machine (the smart toothbrush) and maintain safe and stable operating of the system, the battery voltage cannot be lower than 3.28V. The initialization process of the lower machine is shown in FIG. 5. Specifically, when the battery voltage is less than 3.28V, the lower machine is forced to shut down and enter deep sleep; when the battery voltage is greater than 3.28V, the lower machine is powered on and starts running, the system is initialized, and the lower machine remains in deep sleep.

In some embodiments, as shown in FIG. 6, the lower machine (the smart toothbrush) has four wake-up sources:

Wake up by raising your head, wake up by heartbeat timing of wireless communication, wake up by charging detection and wake up by pressing a physical button. When the lower machine is in deep sleep state, it can be awakened by the above four wake-up sources to enter the working mode. When the current work of the lower machine is completed, it will re-enter the deep sleep state through timing to save power consumption.

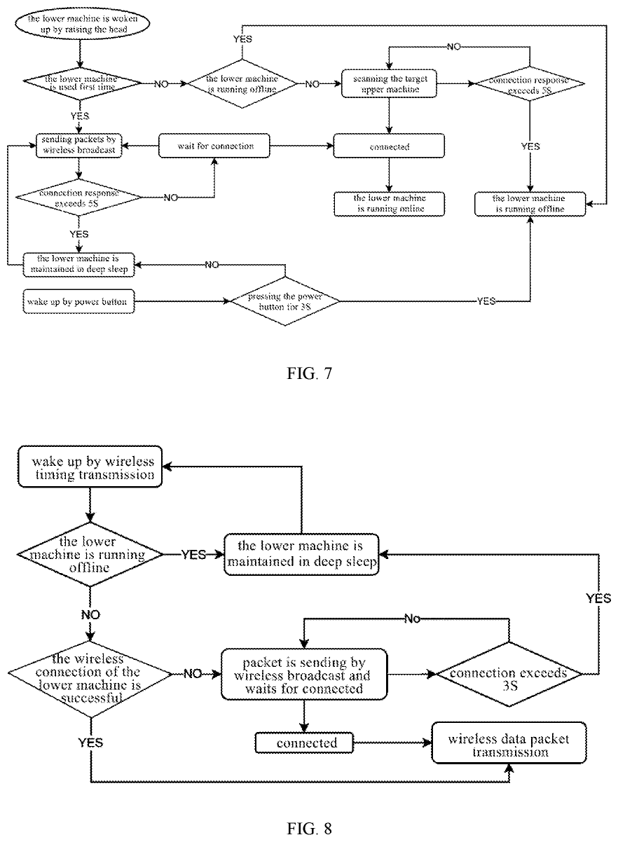

In some embodiments, as shown in FIG. 7, when the lower machine (the smart toothbrush) is used by the user for the first time, the user picks up the lower machine and triggers the lower machine to raise its head to wake up, then broadcasts data and waits for pairing with the upper machine. The data broadcast has a preset time period (for example, 60 seconds). If the data broadcast time exceeds the preset time period and has not been connected to the upper machine, the user needs to perform key operations to allow the lower machine to broadcast the preset time period again until communication with the upper machine is completed. If the lower machine is still not connected to the upper machine after more than 3 broadcast activations, the lower machine will enter the offline use state. The user can re-pair and connect with the upper machine after long pressing the power button (for example, long pressing for 3 seconds) to restore the factory settings.

In some embodiments, as shown in FIG. 8, when the lower machine (the smart toothbrush) is awakened by a wireless communication heartbeat, the lower machine can establish a communication connection with the upper machine and transmit real-time data, so that the upper machine can synchronously obtain information of the lower machine, and the lower machine can receive the synchronization data sent by the upper machine.

Optionally, the method also includes:

After detecting the first upgrade request sent by the upper machine, downloading the first data packet from the upper machine;

Verifying the first data packet, and sending an upgrade mode request to the upper machine after the verification is successful;

performing firmware upgrade according to the first data packet, according to the upgrade mode confirmation information fed back by the upper machine;

The upgrade method includes scheduled upgrade and/or upgrade during idle.

Optionally, the performing firmware upgrade according to the first data packet, according to the upgrade mode confirmation information fed back by the upper machine, including:

Confirming upgrade time according to the upgrade method confirmation information;

Performing firmware upgrade according to the first data packet at the upgrade time.

Optionally, the performing firmware upgrade according to the first data packet according to the upgrade mode confirmation information fed back by the upper machine, including:

When the smart toothbrush is in an idle state, upgrading the firmware according to the first data packet.

In some embodiments, in order to ensure user experience, the lower machine (the smart toothbrush) needs to perform firmware upgrades from time to time. At the same time, taking advantage of the advantages brought by wireless transmission, the lower machine provides two upgrade methods for users to choose: background method (upgrade when idle and/or scheduled upgrade) and online method.

Optionally, after detecting the first upgrade request sent by the upper machine, it can be understood that: the upper machine detects every time it is started to detect whether the cloud initiates an upgrade request; if the cloud initiates an upgrade request for the lower machine, the upgrade request can be sent to the lower machine through information push; each time the smart toothbrush is started, the information sent by the upper machine will be detected to detect whether there is the first upgrade request.

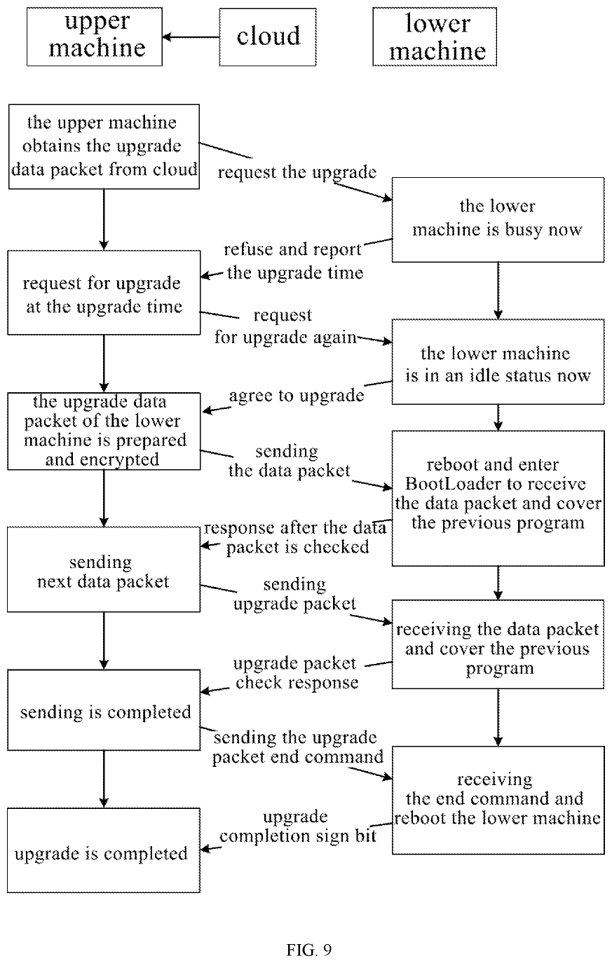

In some embodiments, as shown in FIG. 9, after the upper machine receives an upgrade request from the cloud for the lower machine, it downloads the upgrade data package (the first data package) corresponding to the upgrade request from the cloud; and verify and encrypt the upgrade data packet, and send the first upgrade request to the lower machine through a wireless heartbeat packet;

Regardless of the working mode, after receiving the first upgrade request, the lower machine downloads the encrypted first data packet from the upper machine to the storage space of Bank2, and performs encryption and verification after the download is completed, if the verification is unsuccessful, it will be downloaded again; if the verification is successful, the upgrade method request will be fed back to the upper machine;

Through the upper machine, the user requests to select an upgrade mode (upgrade during idle and/or scheduled upgrade) according to the upgrade mode, and sends the upgrade mode confirmation information to the lower machine;

According to the upgrade mode confirmation information, the lower machine performs firmware upgrade at a specific time or idle time through the first data packet; for example, the lower machine restarts into Bootloader mode and copies the data in Bank2 to Bank1 (program space) . After the copy is completed, the data will be compared. After confirmation is successful, it will restart again and enter the program space of Bank1 to run;

After the upgrade of the lower machine is completed, feedback information that the upgrade is successful is sent to the upper machine.

In the smart toothbrush control method of the embodiment of the present disclosure, the smart toothbrush can be upgraded in schedule or in an idle state according to the user's choice, and can be upgraded without delaying the user's use, which ensures the user's use demand, and also ensures the timeliness of firmware upgrades.

Optionally, the first data package includes a consumables upgrade package, and the performing the firmware upgrade according to the first data packet according to the upgrade mode confirmation information fed back by the upper machine includes:

Detecting the first consumable currently used, and determining the first target data packet corresponding to the first consumable in the first data packet;

Sending the first target data packet to the smart consumable device, and saving the remaining data of the first data packet;

After receiving the upgrade completion information sent by the smart consumable device, reading the first data packet of the first consumable in the smart consumable device and determining whether the first consumable is successfully upgraded;

When it is detected that the second consumable is replaced, detecting the first data packet of the second consumable in the smart consumable device, and after it is determined that the second consumable has not been successfully upgraded, sending the second target data packet corresponding to the second consumable in the first data packet to the smart consumable device.

In some embodiments, the smart toothbrush has a variety of consumables to choose from, but the smart toothbrush cannot upgrade all the consumables that the user is using or not using at one time;

After receiving the first upgrade request from the upper machine, the lower machine (the smart toothbrush) downloads the first data package (including upgrade data packages for all types of consumables) from the upper machine, or directly downloads the first data packet from the cloud server;

Detecting the first consumable currently being used by the lower machine, obtaining the first target data packet corresponding to the first consumable from the first data packet, and upgrading the first consumable according to the first target data packet.

That is to say, the firmware for upgrading consumables can first be downloaded from the upper machine to the lower machine through an over-the-air upgrade. After the upper machine has finished the transfer, the upper machine will notify the lower machine to obtain the updated firmware for all the consumables owned by the user from the cloud, and after receiving the command, the lower machine will directly receive the corresponding firmware from the cloud, the firmware is encrypted and stored, and then the firmware of the currently used consumables will be upgraded.

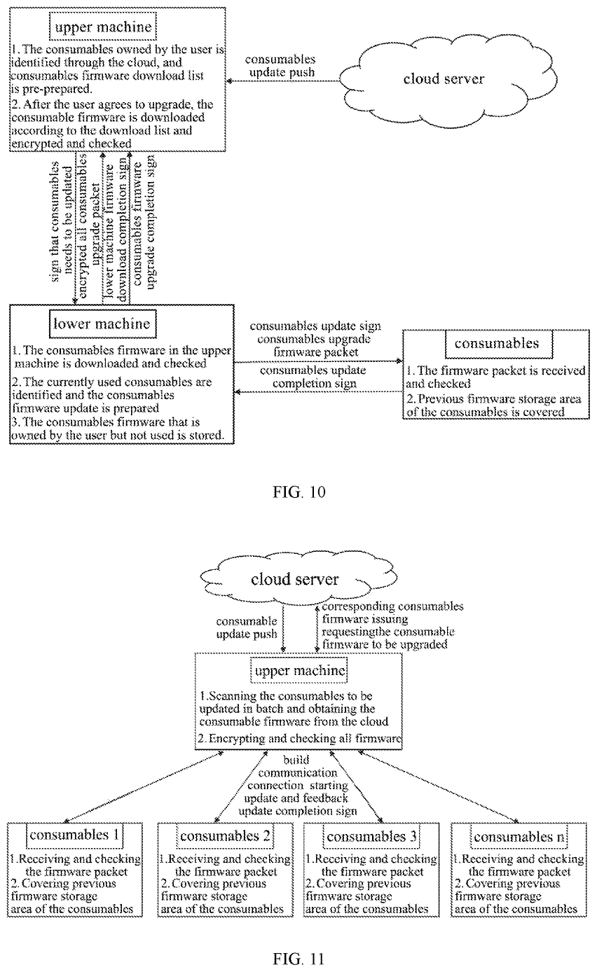

Specifically, the process of firmware upgrade of consumables by the lower machine is shown in FIG. 10: After the lower machine obtains the first data packet of the consumables, it will first perform the firmware verification process. After the verification is completed, the first target data packet of the first consumable is read, and the target area is covered according to the content of the data packet, and written into the consumable;

After the writing is completed, the first target data packet will be read again and verified to determine whether the upgrade is successful. If it fails, the upgrade process will be repeated again;

When the user uses the next consumable, the lower machine will first identify whether the current consumable has completed firmware upgrade. Otherwise, the consumable firmware upgrade process will be performed first. Only after the upgrade is completed the consumable can be used normally.

In other embodiments, the smart consumable device cooperates with the cloud device to perform firmware upgrade through the upper machine, as shown in FIG. 11:

The consumables first establish a connection with the upper machine;

The upper machine downloads the first data packet from the cloud server, performs a CRC check on the first data packet, and compares the check value with a detect value stored in the cloud. If the comparison is consistent, then the data package download is completed. If it is inconsistent, it indicates that there is interference during the download process, so the current data package will be discarded and a new data packet is obtained and downloaded from the cloud again;

After the upper machine completes downloading the first data, it encrypts the first data packet, sends the encrypted first data packet to the consumable through a wireless connection, and upgrades the first data packet to consumables through direct coverage;

After the firmware upgrade is completed, the upper machine will read the firmware data in the consumables and compare it with the first data packet; if the comparison is consistent, the upgrade is completed; if it is inconsistent, the upgrade process needs to be initiated again.

It can be understood that the smart consumable device can realize the firmware upgrade of batch consumables by using the upper machine to cooperate with the cloud device to upgrade the firmware.

Optionally, the data packet carries the following information:

Packet header, data length, data packet type, data content, packet tail, Cyclic Redundancy Check (CRC).

In the smart toothbrush control method of the embodiment of the present disclosure, the upgrade of the smart consumable device can be implemented in a variety of ways, and can be upgraded without delaying the user's use, which not only ensures the user's use needs, but also ensures the timeliness of the firmware upgrade.

Optionally, the method also includes:

After detecting the second upgrade request sent by the upper machine, determining the upgrade time according to the operating status of the smart toothbrush, and feeding back the upgrade time to the upper machine; the upgrade time being a time after the current time;

If the second upgrade request sent by the upper machine is received at the upgrade time, determining whether to upgrade according to the operating status of the smart toothbrush.

Optionally, the current time is the current moment or time point; the upgrade time may be a time point or a time period.

Optionally, the second upgrade request is an Over-the-Air Technology (OTA) upgrade request.

Optionally, the upgrade time is determined based on the preset idle time of the smart toothbrush.

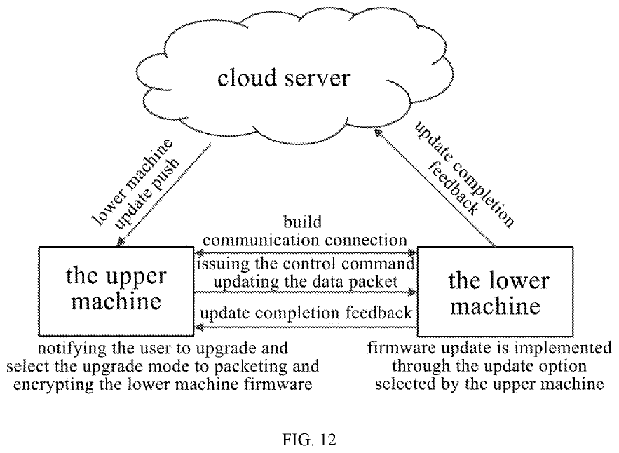

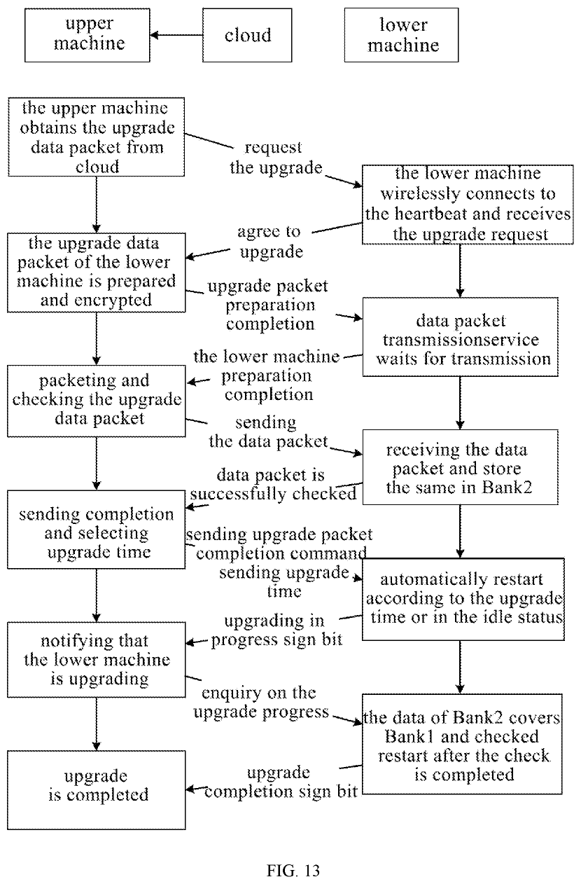

In some embodiments, as shown in FIGS. 12 and 13, in order to ensure user experience, the lower machine (the smart toothbrush) performs firmware upgrade through online upgrade:

After receiving the over-the-air upgrade request (the second upgrade request) sent by the upper machine, the lower machine will reply to the upper machine whether to accept the upgrade according to the current working status; when the lower machine is busy, the upgrade will not be performed and the estimated time (the upgrade time) that busy time end is fed back to the upper machine so that the upper machine can re-initiate the upgrade request at the upgrade time;

The lower machine will only agree to the upgrade request of the upper machine when it is idle, and at the same time, it will enter the over-the-air upgrade waiting state. When the upper machine receives the upgrade consent command from the lower machine, it can start the over-the-air upgrade and automatically restart after the upgrade is completed;

Feeding back the upgrade success information to the upper machine;

If the duration that the lower machine waits in the air is longer than the a preset duration (for example, 60 s), it will exit this upgrade and keep the original program to continue running;

During the over-the-air upgrade process, the upgrade can be terminated through the upper machine and the original program can be retained to continue running.

In the smart toothbrush control method of the embodiment of the present disclosure, the smart toothbrush is upgraded online according to the user's choice, and can be upgraded without delaying the user's use, which not only ensures the user's use needs, but also ensures that the timeliness of the firmware upgrade.

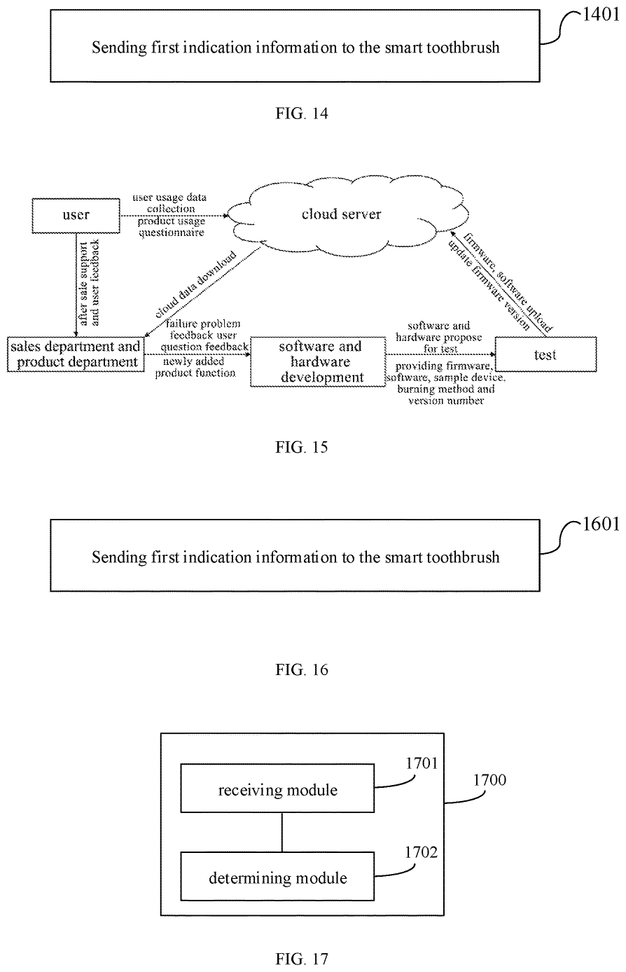

As shown in FIG. 14, the smart toothbrush control method according to the embodiment of the present disclosure is applied to the upper machine and includes the following steps:
Step 1401: Sending first indication information to the smart toothbrush;
The first indication information is used to indicate at least one of the following: the operating mode of the smart toothbrush, the type of consumables, the amount of consumables, user oral data collection, consumable usage status collection, and smart toothbrush usage status collection.

Optionally, before sending the first indication information to the smart toothbrush, the method includes:

Receiving the first control data input by the user, and/or the second control data sent by the cloud device;

Determining first indication information according to the first control data and/or the second control data.

In the smart toothbrush control method of the embodiment of the present disclosure, the smart toothbrush determines the target operating program based on the first indication information sent by the target device including the upper machine and/or the smart consumable device, and the user can customize the operating mode, types of the consumables and amount of consumables through the target device, thereby achieving a personalized tooth brushing experience and solving the problems of existing electric toothbrushes with fixed modes, simple functions and low efficiency in switching modes.

Optionally, the method also includes:

Receiving at least one of the following collection data sent by the smart toothbrush:

The user's oral data, the usage status of the consumables, and the usage status of the smart toothbrush;

Sending at least one of the collected data to the cloud device.

Optionally, the method also includes:

Receiving a third upgrade request sent by the cloud device;

Upon receiving the indication information input by the user to confirm the upgrade, downloading the second data package for the upgrade from the cloud device;

Upgrading the upper machine according to the second data package.

Relevant developers of upper machines, lower machines and smart consumable device will regularly collect user feedback data and test data fed back by the testing department, and perform regular maintenance of the firmware based on user feedback data and test data fed back by the testing department, as shown in FIG. 15.

After the developers complete the development, the testing department will first conduct functional testing and reliability testing of the attachment based on user feedback data (which contains user feedback issues). After the test is completed, the person in charge of the test department uploads the firmware (upgrade data package) to the cloud, while retaining the original program in the server; if the test fails, the problem will be fed back to the developer for repair and the next round of testing will begin; when the firmware is uploaded to the cloud, it will first be encrypted through an internal encryption algorithm (such as symmetric encryption algorithm, asymmetric encryption algorithm, Hash algorithm, etc.), after the encryption is completed, it will be uploaded to the cloud, and after the upload is completed, the firmware is downloaded from the cloud and verified to ensure the correctness of the firmware.

After some areas of the upper machine software of the cloud device are updated by the developer, the user will receive an update notification (the third upgrade request) when opening the software on the upper machine and be notified of this update content. The user can selectively update the program. After the user agrees, the software will download the software installation package from the cloud or the software store that comes with the upper machine (such as a mobile phone). When the download is complete, it will prompt for installation or automatic installation and update completion;

When the user postpones the update three times, some closely related functions after the update will not be available, and the user will need to agree to download and update the program before it can be used normally.

Optionally, the method also includes:

When detecting the first upgrade request sent by the cloud device, sending the first upgrade request to the smart toothbrush;

Receiving an upgrade method request from the smart toothbrush feedback;

Determining the upgrade mode confirmation information of the smart toothbrush according to the third control data input by the user;

Sending the upgrade mode confirmation information to the smart toothbrush.

Optionally, the method also includes:

In the case that the second upgrade request sent by the cloud device is detected, sending the second upgrade request to the smart toothbrush; the second upgrade request being used to instruct the firmware upgrade of the smart consumable device;

Receiving the upgrade time feedback from the smart toothbrush;

If the upgrade time is a time after the current time, sending the second upgrade request to the smart toothbrush at the upgrade time.

Optionally, the method also includes:

If the duration between the upgrade time and the current time is greater than a preset value, exiting this upgrade.

As shown in FIG. 16, the smart toothbrush control method according to the embodiment of the present disclosure is applied to smart consumable equipment and includes the following steps:

Step 1601: Sending first indication information to the smart toothbrush;

The first indication information is used to indicate at least one of the following: the operating mode of the smart toothbrush, usage amount of consumables, collection and storage of user oral data, collection and storage of consumable usage status, and collection and storage of usage status of the smart toothbrush;

Determining the first indication information based on user data stored in the smart consumable device.

In the smart toothbrush control method of the embodiment of the present disclosure, the smart toothbrush determines the target operating program based on the first indication information sent by the target device including the upper machine and/or the smart consumable device, and the user can customize the operating mode, types of consumables and amount of consumables through the target device, thereby achieving a personalized tooth brushing experience and solving the problems of existing electric toothbrushes with fixed modes, simple functions and low efficiency in switching modes.

Optionally, the method also includes:

Receiving a first target data packet sent by the smart toothbrush, wherein the first target data packet is an upgrade package corresponding to the first consumable contained in the smart consumable device;

Performing firmware upgrade of the smart consumable device according to the first target data package.

Optionally, the method also includes:

Downloading the second data package from the cloud device;

Performing firmware upgrade according to the second data package.

As shown in FIG. 17, the smart toothbrush control device 1700 of the embodiment of the present disclosure includes:

a receiving module 1701, configured to receive the first indication information sent by the target device; the first indication information being used to indicate at least one of the following: the operating mode of the smart toothbrush, the type of consumables, the amount of consumables, user oral data collection, consumables usage status collection and smart toothbrush usage status collection;

a determining module 1702, configured to determine the target operating program corresponding to the first indication information, and execute the target operating program;

The target device includes: an upper machine and/or a smart consumable device.

In the smart toothbrush control device of the embodiment of the present disclosure, the smart toothbrush determines the target operating program based on the first indication information sent by the target device including the upper machine and/or the smart consumable device, and the user can customize the operating mode, types of consumables and amount of consumables through the target device, thereby achieving a personalized tooth brushing experience and solving the problems of existing electric toothbrushes with fixed modes, simple functions and low efficiency in switching modes.

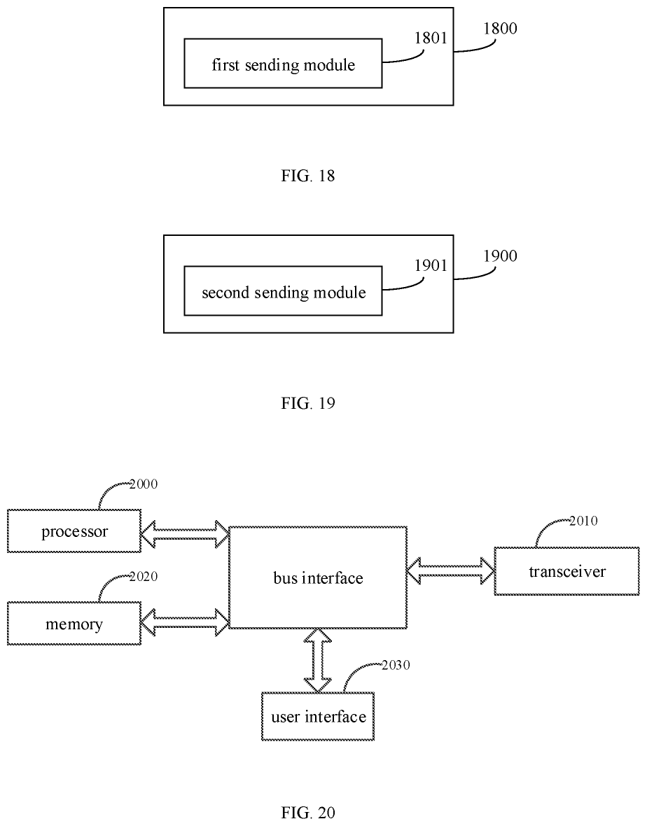

As shown in FIG. 18, the smart toothbrush control device 1800 according to the embodiment of the present disclosure includes:

a first sending module 1801, configured to send the first indication information to the smart toothbrush;

The first indication information is used to indicate at least one of the following: the operating mode of the smart toothbrush, the type of consumables, the amount of consumables, user oral data collection, consumable usage status collection, and smart toothbrush usage status collection.

As shown in FIG. 19, the smart toothbrush control device 1900 according to the embodiment of the present disclosure includes:

a second sending module 1901, configured to send the first indication information to the smart toothbrush;

The first indication information is used to indicate at least one of the following: the operating mode of the smart toothbrush, usage amount of consumables, collection and storage of user oral data, collection and storage of consumable usage status, and collection and storage of usage status of the smart toothbrush;

Determining the first indication information based on user data stored in the smart consumable device.

A terminal device according to another embodiment of the present disclosure, as shown in FIG. 20, includes a transceiver 2010, a processor 2000, a memory 2020, and a program stored on the memory 2020 and executed by the processor 2000; when the processor 2000 executes the program or instructions, the above control method applied to the smart toothbrush is implemented.

The transceiver 2010 is used to receive and send data under the control of the processor 2000.

In FIG. 20, the bus architecture may include any number of interconnected buses and bridges, various circuits of specifically one or more processors represented by processor 2000 and the memory represented by memory 2020 are linked together. The bus architecture can also link together various other circuits such as peripherals, voltage regulators, and power management circuits, which are all well known in the art and therefore will not be described further herein. The bus interface provides the interface. Transceiver 2010 may be a plurality of elements, including a transmitter and a receiver, providing a unit for communicating with various other devices over a transmission medium. For different user devices, the user interface 2030 can also be an interface capable of externally or internally connecting the required equipment. The connected equipment includes but is not limited to a small keyboard, a display, a speaker, a microphone, a joystick, etc.

The processor 2000 is responsible for managing the bus architecture and general processing, and the memory 2020 can store data used by the processor 2000 when performing operations.

A readable storage medium according to an embodiment of the present disclosure has a program or instructions stored thereon. When the program or instructions are executed by a processor, the steps in the smart toothbrush control method as described above are implemented and the same technical effect can be achieved, repetition will be avoided here.

It should be further noted that the terminal devices described in this specification include but are not limited to smartphones, tablet computers, etc., and many of the functional components described are called modules to more specifically emphasize the independence of their implementation.

In embodiments of the present disclosure, modules may be implemented in software so as to be executed by various types of processors. For example, an identified module of executable code may include one or more physical or logical blocks of computer instructions, which may be structured, for example, as an object, procedure, or function. Nonetheless, the executable code of an identified module need not be physically located together, but may include different instructions stored on different bits that, when logically combined, constitute the module and implement the purpose of the module.

In fact, an executable code module can be a single instruction or many instructions, and can even be distributed over multiple different code segments, distributed among different programs, and distributed across multiple memory devices. Likewise, operational data may be identified within modules and may be implemented in any suitable form and organized within any suitable type of data structure. The operational data may be collected as a single data set, or may be distributed over different locations (including on different storage devices), and may exist, at least in part, solely as electronic signals on a system or network.

When the module can be implemented using software, taking into account the level of existing hardware technology, those skilled in the art can build corresponding hardware circuits to implement the corresponding functions without considering the cost. The hardware circuits include conventional very large scale integration (VLSI) circuits or gate arrays, as well as existing semiconductors such as logic chips, transistors, or other discrete components. Modules can also be implemented using programmable hardware devices, such as field programmable gate arrays, programmable array logic, programmable logic devices, etc.

The above are only preferred embodiments of the present disclosure. It should be pointed out that for those of ordinary skill in the art, several improvements and modifications can be made without departing from the principles of the present disclosure. These improvements and modifications shall also fall within the scope of the present disclosure.

1. A smart toothbrush control method, applied to a smart toothbrush, comprising:
receiving first indication information sent by a target device; wherein the first indication information is used to indicate at least one of the following: an operating mode of the smart toothbrush, a type of consumables, an amount of the consumables, user oral data collection, consumable usage status collection and smart toothbrush usage status collection;
determining a target operating program corresponding to the first indication information, and executing the target operating program;
wherein the target device includes an upper machine and/or a smart consumable device.

2. The smart toothbrush control method according to claim 1, wherein the operating mode of the smart toothbrush includes at least one of the following:
a movement mode, vibration intensity, a working frequency and working duration of a toothbrush head;
the type of consumables include toothpaste, mouthwash and a cleaning agent.

3. The smart toothbrush control method according to claim 1, wherein the target device includes the upper machine, and the determining a target operating program corresponding to the first indication information, and executing the target operating program includes:
determining the target operating program according to the first indication information;
wherein the target operating program includes: using target consumables with a target amount, running in a target operating state, and sending at least one of the following to the upper machine and/or a cloud device: the user oral data, a usage status of the consumables, and a usage status of the smart toothbrush.

4. The smart toothbrush control method according to claim 1, wherein the target device includes the smart consumable device, and determining the target operating program corresponding to the first indication information and executing the target operating program includes:
determining the target operating program according to the first indication information;
wherein the target operating program includes: using a target amount of consumables, running in a target operating state, and storing at least one of the following: the user oral data, a usage status of the consumables, and a usage status of the smart toothbrush;
the first indication information is determined based on user data stored in the smart consumable device.

5. The smart toothbrush control method according to claim 1, further comprising:
after detecting a first upgrade request sent by the upper machine, downloading a first data packet from the upper machine;
verifying the first data packet, and sending an upgrade mode request to the upper machine after the verification is successful;
performing firmware upgrade according to the first data packet, according to upgrade mode confirmation information fed back by the upper machine;
wherein the upgrade mode includes scheduled upgrade and/or upgrade during idle

6. The smart toothbrush control method according to claim 5, wherein the first data package includes a consumables upgrade package, and the performing the firmware upgrade according to the first data packet according to the upgrade mode confirmation information fed back by the upper machine includes:
detecting a first consumable currently used, and determining a first target data packet corresponding to the first consumable in the first data packet;
sending the first target data packet to the smart consumable device, and saving remaining data of the first data packet;
after receiving the upgrade completion information sent by the smart consumable device, reading the first data packet of the first consumable in the smart consumable device and determining whether the first consumable is successfully upgraded;
when it is detected that a second consumable is replaced, detecting a first data packet of the second consumable in the smart consumable device, and after it is determined that the second consumable has not been successfully upgraded, sending a second target data packet corresponding to the second consumable in the first data packet to the smart consumable device.

7. The smart toothbrush control method according to claim 1, further comprising:
after detecting the second upgrade request sent by the upper machine, determining a upgrade time according to the operating status of the smart toothbrush, and feeding back the upgrade time to the upper machine; the upgrade time being a time after a current time;
if the second upgrade request sent by the upper machine is received at the upgrade time, determining whether to upgrade according to the operating status of the smart toothbrush.

8. A smart toothbrush control method, applied to an upper machine, comprising:
sending first indication information to a smart toothbrush;
wherein the first indication information is used to indicate at least one of the following: an operating mode of the smart toothbrush, a type of consumables, a amount of consumables, user oral data collection, consumable usage status collection, and smart toothbrush usage status collection.

9. The method according to claim 8, further comprising:
receiving at least one of the following collection data sent by the smart toothbrush:
the user oral data, the usage status of the consumables, and the usage status of the smart toothbrush;
sending at least one of the collection data to a cloud device.

10. The method according to claim 8, further comprising:
receiving a third upgrade request sent by the cloud device;
upon receiving indication information input by a user to confirm the upgrade, downloading a second data package for the upgrade from the cloud device;
upgrading the upper machine according to the second data package.

11. The method according to claim 8, further comprising:
when a first upgrade request sent by the cloud device is detected, sending the first upgrade request to the smart toothbrush;
receiving an upgrade mode request fed back the smart toothbrush;
determining upgrade mode confirmation information of the smart toothbrush according to third control data input by the user;
sending the upgrade mode confirmation information to the smart toothbrush.

12. The method according to claim 8, further comprising:
when a second upgrade request sent by the cloud device is detected, sending the second upgrade request to the smart toothbrush; the second upgrade request being used to indicate the firmware upgrade of the smart consumable device;
receiving an upgrade time fed back by the smart toothbrush;
when the upgrade time is a time after a current time, sending the second upgrade request to the smart toothbrush at the upgrade time.

13. The method according to claim 12, further comprising:
when a duration between the upgrade time and the current time is greater than a preset value, exiting the current upgrade.

14. A smart toothbrush control method, applied to a smart consumable device, comprising:
sending first indication information to a smart toothbrush;
wherein the first indication information is used to indicate at least one of the following: an operating mode of the smart toothbrush, a usage amount of consumables, collection and storage of user oral data, collection and storage of usage status of consumables, and collection and storage of usage status of the smart toothbrush;
the first indication information is determined based on user data stored in the smart consumable device.

15. The method according to claim 14, further comprising:
receiving a first target data packet sent by the smart toothbrush, wherein the first target data packet is an upgrade package corresponding to a first consumable contained in the smart consumable device;
performing firmware upgrade of the smart consumable device according to the first target data package.

16. The method according to claim 14, further comprising:
downloading a second data package from a cloud device;
performing firmware upgrade according to the second data package.

17-19. (canceled).

20. A terminal, comprising: a transceiver, a processor, a memory, and a program or instructions stored on the memory and executed by the processor; when the processor executes the program or instructions to implement the smart toothbrush control method according to claim 1.

21. A readable storage medium, storing a computer program, and when the computer program is executed by a processor, the steps of the method according to claim 1 are implemented.

22. A terminal, comprising: a transceiver, a processor, a memory, and a program or instructions stored on the memory and executed by the processor; when the processor executes the program or instructions to implement the smart toothbrush control method according to claim 8.

23. A terminal, comprising: a transceiver, a processor, a memory, and a program or instructions stored on the memory and executed by the processor; when the processor executes the program or instructions to implement the smart toothbrush control method according to claim 14.
